(19) United States
(12) Patent Application Publication
(10) Pub. No.: US 2024/0331536 A1
(43) Pub. Date: Oct. 3, 2024

(54) ROAD SIGN INTERPRETATION SYSTEM FOR ASSOCIATING UNIDENTIFIED ROAD SIGNS WITH A SPECIFIC ALLOWED MANEUVER

(71) Applicant: GM Global Technology Operations LLC, Detroit, MI (US)

(72) Inventors: Alireza Esna Ashari Esfahani, Novi, MI (US); Brent Navin Roger Bacchus, Sterling Heights, MI (US); Bo Yu, Troy, MI (US)

(21) Appl. No.: 18/193,956

(22) Filed: Mar. 31, 2023

(51) Int. Cl. G08G 1/0967; B60W 60/00; G08G 1/09

(52) U.S. Cl. CPC G08G 1/096725; B60W 60/001; G08G 1/091; B60W 2555/60; B60W 2556/65; B60W 2756/10

(57) ABSTRACT

A crowd-sourced road sign interpretation system includes one or more central computers in wireless communication with a plurality of vehicles and a network that transmits map data. The one or more central computers execute instructions to perform a statistical hypothesis test of telemetry data collected at one or more trajectory segments including a specific allowed maneuver and the presence of the one or more unidentified road signs, and the telemetry data collected at one or more trajectory segments including the specific allowed maneuver without the presence of the one or more unidentified road sign to determine a statistical impact of the presence of the one or more unidentified road signs upon the specific allowed maneuver.

### INTRODUCTION

The present disclosure relates to a crowd-sourced road sign interpretation system that associates unidentified road signs with a specific allowed maneuver based on a statistical hypothesis test of telemetry data collected by a plurality of vehicles.

An autonomous vehicle executes various tasks such as, but not limited to, perception, localization, mapping, path planning, decision making, and motion control. For example, an autonomous vehicle may include perception sensors such as a camera for collecting image data regarding the environment surrounding the vehicle. The autonomous vehicle may include a road sign interpretation system that relies on various computationally intensive algorithms for semantic understanding of the text displayed by the road sign such as, for example, object detection, instance segmentation, scene text recognition (STR) algorithms and natural language processing algorithms. The road sign interpretation system may interpret the road signs, which have text stating instructions for the road vehicles to follow, based on the various algorithms. However, it is to be appreciated that some types of autonomous driving systems may have limited computational power, which affects the ability of the autonomous driving system to execute the algorithms in real-time to understanding the text displayed by the road signs.

In addition to the above-mentioned challenges, some types of road signs may be informational road signs that contain text or symbols that are ambiguous in meaning. Specifically, some types of road signs do not include specific text or symbols containing explicit instructions for the road vehicles to follow, and instead only contain information informing users of various conditions in the environment. That is, in other words, many road signs do not indicate which maneuver a vehicle is supposed to execute, but only provide information. Furthermore, it is also to be appreciated that a vehicle may also encounter occluded road signs as well, where the occlusion may occur because of inadequate lighting, too much lighting, or obstructions such as trees or other vehicles. Therefore, it may be difficult for the autonomous driving system to determine maneuvers based on an informational road sign.

As another example, some types of road signs may contain multiple sets of instructions to vehicles based on which lane the vehicle is situated within. The sign interpretation system may find the multiple sets of instructions confusing. Furthermore, some road signs may be dynamic in nature, which means they change their instructions over time depending upon traffic patterns and the time of day.

Thus, while road sign interpretation systems for autonomous vehicles achieve their intended purpose, there is a need in the art for an improved approach for interpreting road signs based on crowd-sourced information.

### SUMMARY

According to several aspects, a crowd-sourced road sign interpretation system is disclosed. The crowd-sourced road sign interpretation system includes a plurality of vehicles that each include a plurality of sensors and systems that collect telemetry data and perception data, where the perception data includes image data of a plurality of unidentified road signs, and one or more central computers in wireless communication with each of the plurality of vehicles and a network that transmits map data. The one or more central computers execute instructions to classify portions a road represented by the map data into a plurality of scenarios. The central computers match the telemetry data from the plurality of vehicles to a specific scenario where the telemetry data was originally collected by one of the plurality of vehicles. The central computers segment a trajectory into a plurality of trajectory segments based on an allowed maneuver and a speed limit associated with each trajectory segment. The central computers group the telemetry data collected at the plurality of trajectory segments based on the presence of one or more unidentified road signs. The central computers perform a statistical hypothesis test of the telemetry data collected at one or more trajectory segments including a specific allowed maneuver and the presence of the one or more unidentified road signs and the telemetry data collected at one or more trajectory segments including the specific allowed maneuver without the presence of the one or more unidentified road sign to determine a statistical impact of the presence of the one or more unidentified road signs upon the specific allowed maneuver. In response to determining the one or more unidentified road signs are statistically correlated with the specific allowed maneuver, the central computers associate the one or more unidentified road signs with the specific allowed maneuver.

In another aspect, the one or more central computers execute instructions to in response to determining the one or more unidentified road signs are not statistically correlated with the specific allowed maneuver, determine an absence of a relationship between the one or more unidentified road signs and the specific allowed maneuver.

In yet another aspect, wherein the one or more central computers execute instructions to in response to determining the absence of a relationship between the one or more unidentified road signs and the specific allowed maneuver, select another unique maneuver as the specific allowed maneuver, and re-execute the statistical hypothesis test of the telemetry data.

In an aspect, a scenario refers to a geometry, a capacity, and an allowed maneuver associated with a specific portion of the road.

In another aspect, the one or more unidentified road signs represent a cluster of unidentified road signs that each share the same message conveyed by an identifier.

In yet another aspect, the identifier includes one of more of the following: text and symbols.

In an aspect, the one or more central computers execute instructions to receive the perception data from the plurality of vehicles, wherein the perception data includes the image data of the plurality of unidentified road signs and interpret the plurality of unidentified road signs to determine the identifier associated with each of the plurality of unidentified road signs.

In another aspect, the one or more central computers execute instructions to determine one or more clusters of unidentified road signs based on the identifiers associated with each of the plurality of unidentified road signs, where each cluster of unidentified road signs share the same information conveyed by the identifier.

In yet another aspect, the image data includes a road sign with two or more separate identifiers, and where the one or more central computers execute instructions to parse the road sign into two or more unique identifiers, wherein the two or more unique identifiers are each analyzed as a separate road sign.

In an aspect, the statistical hypothesis test includes one of the following: Fisher's exact test and Bayesian Region of Practical Equivalence (ROPE).

In another aspect, the unidentified road signs include dynamic road signs.

In yet another aspect, a method for associating unidentified road signs with a specific allowed maneuver based on a statistical hypothesis test of telemetry data collected by a plurality of vehicles is disclosed. The method includes classifying, by one or more central computers, portions a road represented by map data into a plurality of scenarios, where the one or more central computers are in wireless communication with each of the plurality of vehicles and a network that transmits the map data. The method also includes matching the telemetry data from the plurality of vehicles to a specific scenario where the telemetry data was originally collected by one of the plurality of vehicles. The method also includes segmenting a trajectory into a plurality of trajectory segments based on an allowed maneuver and a speed limit associated with each trajectory segment. The method includes grouping the telemetry data collected at the plurality of trajectory segments based on the presence of one or more unidentified road signs. The method includes performing a statistical hypothesis test of the telemetry data collected at one or more trajectory segments including a specific allowed maneuver and the presence of the one or more unidentified road signs and the telemetry data collected at one or more trajectory segments including the specific allowed maneuver without the presence of the one or more unidentified road sign to determine a statistical impact of the presence of the one or more unidentified road signs upon the specific allowed maneuver. In response to determining the one or more unidentified road signs are statistically correlated with the specific allowed maneuver, the method includes associating the one or more unidentified road signs with the specific allowed maneuver.

In another aspect, the method further comprises in response to determining the one or more unidentified road signs are not statistically correlated with the specific allowed maneuver, determining an absence of a relationship between the one or more unidentified road signs and the specific allowed maneuver.

In yet another aspect, in response to determining the absence of a relationship between the one or more unidentified road signs and the specific allowed maneuver, the method includes selecting another unique maneuver as the specific allowed maneuver, and re-executing the statistical hypothesis test of the telemetry data.

In an aspect, the method further comprises receiving perception data from the plurality of vehicles, where the perception data includes image data of a plurality of unidentified road signs. The method includes interpreting the plurality of unidentified road signs to determine an identifier associated with each of the plurality of unidentified road signs.

In another aspect, the method further comprises determining one or more clusters of unidentified road signs based on the identifiers associated with each of the plurality of unidentified road signs, where each cluster of unidentified road signs share the same information conveyed by the identifier.

In an aspect, a crowd-sourced road sign interpretation system is disclosed and includes a plurality of vehicles that each include a plurality of sensors and systems that collect telemetry data and perception data, where the perception data includes image data of a plurality of unidentified road signs, and one or more central computers in wireless communication with each of the plurality of vehicles and a network that transmits map data. The one or more central computers execute instructions to classify portions a road represented by the map data into a plurality of scenarios, where a scenario refers to a geometry, a capacity, and an allowed maneuver associated with a specific portion of the road. The central computers match the telemetry data from the plurality of vehicles to a specific scenario where the telemetry data was originally collected by one of the plurality of vehicles. The central computers segment a trajectory into a plurality of trajectory segments based on an allowed maneuver and a speed limit associated with each trajectory segment. The central computers group the telemetry data collected at the plurality of trajectory segments based on the presence of one or more unidentified road signs. The central computers perform a statistical hypothesis test of the telemetry data collected at one or more trajectory segments including a specific allowed maneuver and the presence of the one or more unidentified road signs and the telemetry data collected at one or more trajectory segments including the specific allowed maneuver without the presence of the one or more unidentified road sign to determine a statistical impact of the presence of the one or more unidentified road signs upon the specific allowed maneuver. In response to determining the one or more unidentified road signs are statistically correlated with the specific allowed maneuver, the central computers associate the one or more unidentified road signs with the specific allowed maneuver. In response to determining the one or more unidentified road signs are not statistically correlated with the specific allowed maneuver, the central computers determine an absence of a relationship between the one or more unidentified road signs and the specific allowed maneuver. In response to determining the absence of the relationship between the one or more unidentified road signs and the specific allowed maneuver, the central computers select another unique maneuver as the specific allowed maneuver and re-execute the statistical hypothesis test of the telemetry data.

In another aspect, one or more unidentified road signs represent a cluster of unidentified road signs that each share the same message conveyed by an identifier.

In another aspect, the identifier includes one of more of the following: text and symbols.

In yet another aspect, the one or more central computers execute instructions to receive the perception data from the plurality of vehicles, wherein the perception data includes the image data of the plurality of unidentified road signs and interpret the plurality of unidentified road signs to determine the identifier associated with each of the plurality of unidentified road signs.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of the disclosed crowd-sourced road sign interpretation system including one or more central computers in wireless communication with a plurality of vehicles that collect telemetry data, according to an exemplary embodiment;

FIG. 2 is a diagram of the one or more central computers shown in FIG. 1, according to an exemplary embodiment;

FIGS. 3A-3D illustrate examples of trajectory segments with and without a road sign, where telemetry data is collected for the corresponding maneuvers of the vehicles traversing the trajectory segments for statistical hypothesis testing, according to an exemplary embodiment;

FIG. 4A illustrates an exemplary road sign, according to an exemplary embodiment;

FIG. 4B illustrates another exemplary road sign including more than one identifier, according to an exemplary embodiment;

FIG. 5 is a process flow diagram illustrating a method for associating unidentified road signs with a specific allowed maneuver based on a statistical hypothesis test of the telemetry data collected by the plurality of vehicles, according to an exemplary embodiment; and

FIG. 6 is an exemplary process flow diagram illustrating a method for performing statistical hypothesis testing, according to an exemplary embodiment.

### DETAILED DESCRIPTION

The following description is merely exemplary in nature and is not intended to limit the present disclosure, application, or uses.

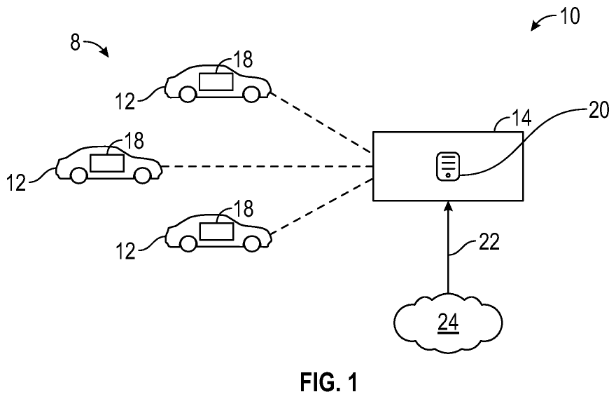

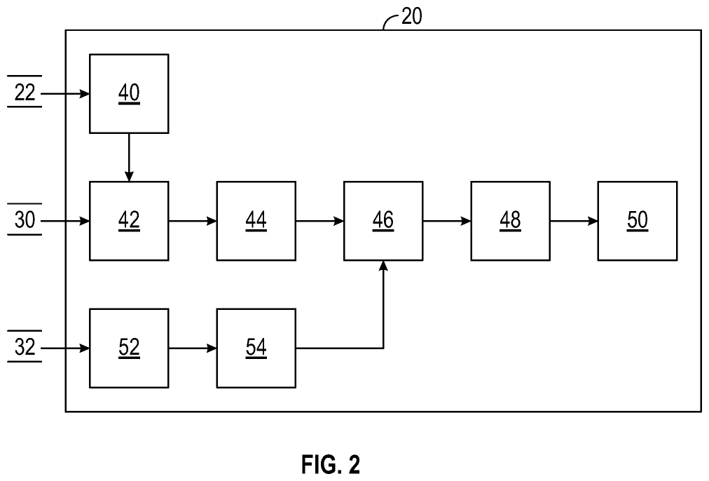

Referring to FIG. 1, an exemplary crowd-sourced road sign interpretation system 10 for associating unidentified road signs with an assigned vehicle maneuver is illustrated. The crowd-sourced road sign interpretation system 10 includes a plurality of vehicles 12 in wireless communication with a back-end office 14. The plurality of vehicles 12 may include any type of vehicle having wireless capabilities for connecting to the back-end office 14 such as, but not limited to, a sedan, truck, sport utility vehicle, van, or motor home. Each of the plurality of vehicles 12 include a plurality of sensors and systems 18 that collect telemetry data 30 and perception data 32 (shown in FIG. 2), where the telemetry data 30 and the perception data 32 for each of the plurality of vehicles 12 is sent to the back-end office 14. The back-end office 14 also receives map data 22 over a network 24. The back-end office 14 includes one or more central computers 20 for aggregating and analyzing the telemetry data and the perception data from the plurality of vehicles 12 in in combination with the map data 22 to associate unidentified road signs located in a surrounding environment 8 with an assigned vehicle maneuver, which is explained below.

Referring to FIGS. 1 and 2, the telemetry data 30 from each vehicle 12 includes data such as, but not limited to, positional information collected by a global positioning system (GPS), speed, yaw rate, heading, and acceleration associated with a trajectory. The telemetry data 30 indicates various vehicle maneuvers that are executed by the plurality of vehicles 12. The perception data 32 is collected by a plurality of perception sensors that are part of each vehicle 12 and includes image data collected by one or more cameras that are part of each vehicle 12. In particular, the one or more cameras of each vehicle 12 capture image data of the individual road signs located in the environment 8.

The road signs are erected at the side of or above a road to provide information to the road users. In one non-limiting embodiment, a road sign interpretation system that is part of one of the plurality of vehicles 12 is unable to interpret one or more unidentified road signs. A road sign may be uninterpreted because the message displayed by the road sign is vague, or because of occlusions. For example, a stop sign may be unidentified due to an occlusion. In an embodiment, the unidentified road signs also include dynamic road signs that change explicit instructions or information over time. For example, some lane signs indicating when a particular lane is open may change based on traffic patterns during the day.

FIG. 2 is a diagram illustrating the one or more central computers 20 that are part of the crowd-sourced road sign interpretation system 10 shown in FIG. 1. The one or more central computers 20 include an identification by similar scenario module 40, a filtering by location module 42, a maneuver segmentation module 44, an unknown road sign grouping module 46, a statistical impact module 48, an association module 50, a perceptual hash and text encoding module 52, and a sign clustering module 54.

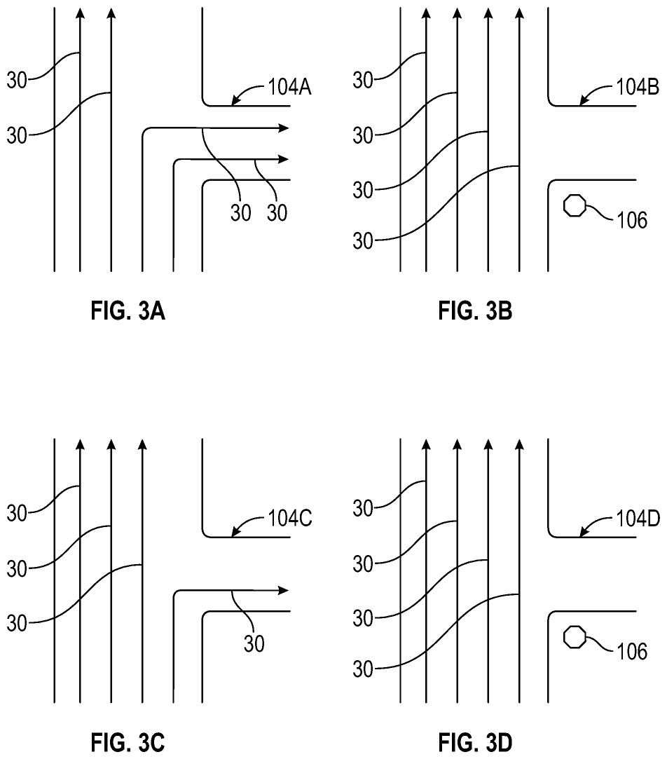

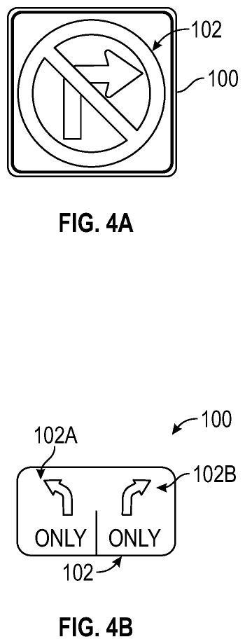

The identification by similar scenario module 40 of the central computers 20 receives the map data 22 as input and classifies portions the road represented by the map data 22 into a plurality of scenarios, where each scenario refers to a geometry, capacity, and an allowed maneuver associated with a specific portion of the road. The geometry refers to a width of the portion of the road and the number of lanes that are included within the road. The capacity of the scenario refers to a traffic volume of the road. The allowed maneuver refers to maneuvers that are physically possible for the vehicle 12 to execute. For example, FIGS. 3A-3D illustrate trajectory segments 104A-104D that each represent a T-intersection. The allowed maneuvers for the T-intersection may include stopping, turning right, or proceeding straight. As explained below, a road sign 100 (shown in FIGS. 4B and 4D) may impose restrictions upon the allowed maneuver. For example, the road sign 106 may indicate no right turn is allowed. Furthermore, it is to be appreciated that FIGS. 3A-3D are merely exemplary in nature, and other types of scenarios may exist as well such as, for example, a four-way intersection or a highway road.

The portions of the road that are classified by scenario are then sent to the filtering by location module 42 of the one or more central computers 20. The filtering by location module 42 of the one or more central computers 20 also receives the telemetry data 30 from the plurality of vehicles 12 (FIG. 1) as well. The filtering by location module 42 matches the telemetry data 30 from the plurality of vehicles 12 to a specific scenario where the telemetry data 30 was originally collected by one of the plurality of vehicles 12. In other words, the filtering by location module 42 associates the telemetry data 30 with the specific scenario along the road where the telemetry data 30 originated from. The filtering by location module 42 may then group the specific scenarios into shared scenarios, where each shared scenario has a similar or common geometry and allowed maneuver. For example, referring to FIGS. 3A-3D, the filtering by location module 42 may first match the telemetry data 30 to a specific trajectory segment 104A-104D based on where the telemetry data 30 was originally collected. The filtering by location module 42 may then group the specific trajectory segments 104A-14D that are part of a shared scenario. In the example as shown in FIGS. 3A-3D, the shared scenario would be the T-intersection. It is to be appreciated that the telemetry data 30 is collected within a predetermined time frame, which may range from one hour to several weeks.

The maneuver segmentation module 44 segments the trajectory of the telemetry data 30 into a plurality of trajectory segments based on the allowed maneuver and a speed limit associated with each trajectory segment. That is, each trajectory segment is associated with one or more allowed maneuvers that may be executed by a vehicle 12. The maneuver segmentation module 44 also identifies the maneuvers the vehicles 12 have executed in a shared scenario for each trajectory segment as well based on the telemetry data 30. For example, as shown in FIGS. 3A-3D, the maneuvers the vehicles 12 have executed in the T-intersection include a right turn and proceeding straight.

The unknown road sign grouping module 46 receives the trajectory segments from the maneuver segmentation module 44 and one or more unidentified road signs from the sign clustering module 54, where the one or more unidentified road signs represent a cluster of unidentified road signs that each share the same message conveyed by an identifier. The identifier for a road sign includes text, symbols, or both text and symbols that convey information or explicit instructions to the road users. For example, two unidentified road signs having the same or similar symbols or text indicating the right lane ahead is closed would be clustered together.

Clustering the unidentified road signs shall now be described. The perceptual hash and text encoding module 52 of the one or more central computers 20 receives crowdsourced perception data 32 from the plurality of vehicles 12 (FIG. 1), where the perception data 32 includes the image data of the plurality of unidentified road signs. The perceptual hash and text encoding module 52 interprets the plurality of unidentified road signs based on perceptual and text encoding techniques that rely upon a code number to determine the identifier associated with each unidentified road sign.

FIG. 4A is an illustration of an exemplary road sign 100 including a single identifier 102. In the example as shown in FIG. 3A, the identifier 102 is a no right turn symbol. Referring to FIG. 4B, in one embodiment, the image data includes a road sign 100 with two or more separate identifiers 102. In the example as shown in FIG. 4B, the road sign 100 includes two different sets of identifiers 102. Specifically, a first identifier 102A represents a right-turn only symbol, and a second identifier 102B represents a left-turn only symbol. Referring to FIGS. 2 and 4B, the perceptual hash and text encoding module 52 of the one or more central computers 20 parses the road sign 100 into two or more unique identifiers 102. It is to be appreciated that the two or more unique identifiers 102 are each analyzed as a separate road sign. The perceptual hash and text encoding module 52 of the one or more central computers 20 then computes the perceptual hash for each identifier.

Referring to FIG. 2, the sign clustering module 54 receives the identifiers associated with unidentified road signs from the perceptual hash and text encoding module 52 and determines one or more clusters of unidentified road signs based on the identifiers associated with each of the plurality of unidentified road signs, which is determined based on perceptual hashing. Each cluster of unidentified road signs share the same information conveyed by the identifier. For example, one cluster of unidentified road signs would include all right-turn only identifiers, while another cluster of unidentified road signs would include all left-turn only identifiers.

The unknown road sign grouping module 46 of the one or more central computers 20 groups the telemetry data 30 collected at the trajectory segments based on the presence of the one or more unidentified road signs. Referring specifically to FIG. 4B, in the event the unidentified road sign 100 includes two or more separate identifiers 102, then the unknown road sign grouping module 46 groups the telemetry data 30 for each separate identifier 102 for a particular unidentified road sign 106. Referring now to FIGS. 3A-3D, the unidentified road sign 106 is located at the second trajectory segment 104B and the fourth trajectory segment 104D. In the event the unidentified road sign 106 at the second trajectory segment 104B and the fourth trajectory segment 104D are both interpreted by the perceptual hash and text encoding module 52 to include the same identifier (i.e., a no right turn identifier) based on perceptual hashing techniques, the telemetry data 30 collected at the second trajectory segment 104B and the fourth trajectory segment 104D would be grouped together. Similarly, the telemetry data 30 collected at the first trajectory segment 104A and the third trajectory segment 104C would be grouped together, since no unidentified road sign exists at either intersection.

The statistical impact module 48 performs a statistical hypothesis test of the telemetry data 30 collected at one or more trajectory segments including the specific allowed maneuver and the presence of the one or more unidentified road signs, and the telemetry data 30 collected at one or more trajectory segments including the specific allowed maneuver without the presence of the one or more unidentified road sign to determine a statistical impact of the presence of the unidentified road signs upon the specific allowed maneuver. That is, the statistical impact module 48 performs statistical hypothesis testing to determine if the presence of the unidentified road sign impacts the occurrence of the specific allowed maneuver. In the event the unidentified road sign includes more than one identifier 102 (i.e., the road sign 100 shown in FIG. 4B), the statistical hypothesis testing is repeated for each identifier 102.

In one approach, the telemetry data 30, which is determined by the unknown road sign grouping module 46, is modeled as having a binomial distribution that is parameterized by a probability of observing the specific allowed maneuver p. The statistical impact module 48 solves for the probability of observing the specific allowed maneuver, where a first probability p0 represents a case where no effect is observed with the presence of the road sign and a second probability p1 represents a case where the presence of the road sign results in a change in observance of the specific allowed maneuver. A null hypothesis H0 represents no effect observed with the presence of the road sign, where the first probability is equal to the second probability, or p0=p1. An alternate hypothesis Ha indicates the presence of the road sign affects the observation, where the first probability is not equal to the second probability. Some examples of statistical hypothesis tests that may be performed include, but are not limited to, Fisher's exact test and the Bayesian Region of Practical Equivalence (ROPE). In one embodiment, the statistical impact module 48 performs the statistical hypothesis testing offline to try and reject the null hypothesis H0. The statistical hypothesis testing may be repeated for each identifier for an unidentified road sign in the event the unidentified road sign includes more than one identifier.

In response to determining the one or more unidentified road signs are statistically correlated with the specific allowed maneuver, the association module 50 associates the one or more unidentified road signs with the specific allowed maneuver. In response to determining the one or more unidentified road signs are not statistically correlated with the specific allowed maneuver, the association module 50 determines an absence of a relationship between the one or more unidentified road signs and the specific allowed maneuver. In an embodiment, in response to determining the absence of the relationship between the one or more unidentified road signs and the specific allowed maneuver, the statistical impact module 48 selects another unique maneuver as the specific allowed maneuver and re-executes the statistical hypothesis test of the telemetry data 30.

FIGS. 3A-3D illustrate an example of the statistical hypothesis test of the telemetry data 30, where similar road trajectory segments with and without an unidentified road sign are shown, where the unidentified road sign indicates no right turn is available (seen in FIG. 4A). FIG. 3A illustrates a first trajectory segment 104A including a plurality of allowed maneuvers including a right-hand turn and proceeding straight, where the first trajectory segment 104A represents a T-intersection where the right-hand turn is available. In the example as shown in FIG. 3A, the first trajectory segment 104A is without the presence of the one or more unidentified road signs, and the telemetry data 30 indicates that two of the plurality of vehicles 12 (FIG. 1) went straight through the T-intersection and two of the plurality of vehicles 12 turned right. FIG. 3B illustrates a second trajectory segment 104B including the specific allowed maneuver that is a right-hand turn, where the second trajectory segment 104B includes the presence of an unidentified road sign 106. In the example as shown in FIG. 3B, the unidentified road sign 106 indicates no right turn (FIG. 4A) and the telemetry data 30 indicates that indicates that all four of the plurality of vehicles 12 (FIG. 1) went straight through the T-intersection. FIG. 3C illustrates a third trajectory segment 104C including a plurality of allowed maneuvers including a right-hand turn and proceeding straight, where the third trajectory segment 104C is without the presence of the unidentified road sign 106. In the example as shown in FIG. 3C, the telemetry data 30 indicates that one of the plurality of vehicles 12 (FIG. 1) turned right and the remaining three vehicles 12 went straight through the T-intersection. Finally, FIG. 3D illustrates a fourth trajectory segment 104D including a plurality of allowed maneuvers including a right-hand turn and proceeding straight, where the fourth trajectory segment 104D includes the presence of the unidentified road sign 106. In the example as shown in FIG. 3D, the telemetry data 30 indicates that all four of the plurality of vehicles 12 (FIG. 1) went straight through the T-intersection.

In the example as shown in FIGS. 3A-3D, the statistical impact module 48 (FIG. 2) determines the unidentified road signs 106 are statistically correlated with the specific allowed maneuver, which is a right-hand turn. In particular, the statistical impact module 48 determines that the presence of the unidentified road sign 106 results in no right-hand turns. Thus, the statistical impact module 48 associates the unidentified road signs 106 with no right-hand turns. Table 1 is a summary of the telemetry data 30 collected at the trajectory segments 104A-104D. The unknown road sign grouping module 46 constructs Table 1, and the statistical impact module 48 performs the statistical hypothesis test of the telemetry data 30, where the null hypothesis H0 is rejected.

TABLE 1

| | | Unidentified sign |
|---|---|---|
| Maneuver | Count | present? |
| Straight | 5 | No |
| Straight-right turn | 3 | No |
| Straight | 8 | Yes |
| Straight-right turn | 0 | Yes |

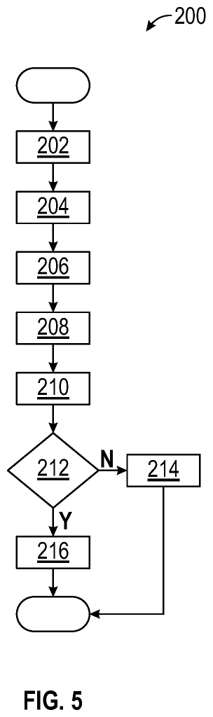

FIG. 5 is a process flow diagram illustrating a method 200 for associating unidentified road signs with a specific allowed maneuver based on the statistical hypothesis test of the telemetry data collected by the plurality of vehicles 12 (shown in FIG. 1). Referring generally to FIGS. 1-5, the method 200 may begin at block 202. In block 202, the identification by similar scenario module 40 of the central computers 20 (FIG. 2) classifies portions the road represented by the map data 22 into the plurality of scenarios, where each scenario refers to the geometry, capacity, and an allowed maneuver associated with a specific portion of the trajectory. The method 200 may then proceed to block 204.

In block 204, the filtering by location module 42 of the one or more central computers 20 match the telemetry data 30 from the plurality of vehicles 12 to a specific scenario where the telemetry data 30 was originally collected by one of the plurality of vehicles 12. The method 200 may then proceed to block 206.

In block 206, the maneuver segmentation module 44 of the one or more central computers 20 segments the trajectory into a plurality of trajectory segments based on observed maneuvers associated with each trajectory segment. The method 200 may then proceed to block 208.

In block 208, the unknown road sign grouping module 46 of the one or more central computers 20 groups the telemetry data 30 collected at the trajectory segments based on the presence of the one or more unidentified road signs. The method 200 may then proceed to block 210.

In block 210, the statistical impact module 48 of the one or more central computers 20 performs the statistical hypothesis test of the telemetry data 30, which is determined by the unknown road sign grouping module 46, collected at one or more trajectory segments at similar geographical locations including the specific allowed maneuver and the presence of the one or more unidentified road signs, and the telemetry data 30 collected at one or more trajectory segments including the specific allowed maneuver without the presence of the one or more unidentified road sign to determine a statistical impact of the presence of the one or more unidentified road signs upon the specific allowed maneuver. The method 200 may then proceed to decision block 212.

In decision block 212, in response to determining the one or more unidentified road signs are not statistically correlated with the specific allowed maneuver, the method 200 may proceed to block 214. In block 214, the association module 50 determines an absence of a relationship between the one or more unidentified road signs and the specific allowed maneuver. In an embodiment, in response to determining the absence of the relationship between the one or more unidentified road signs and the specific allowed maneuver, the statistical impact module 48 selects another unique maneuver as the specific allowed maneuver and re-executes the statistical hypothesis test of the telemetry data 30. Alternatively, the method 200 may terminate.

Referring to decision block 212, in response to determining the one or more unidentified road signs are statistically correlated with the specific allowed maneuver, the method 200 may proceed to block 216. In block 216, the association module 50 associates the one or more unidentified road signs with the specific allowed maneuver. The method 200 may then terminate.

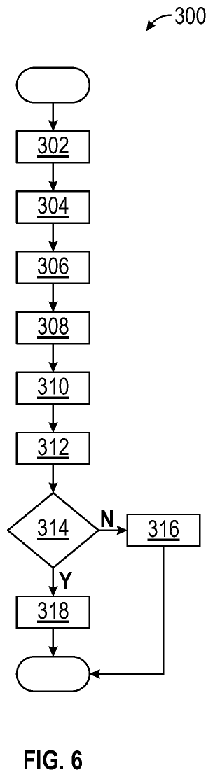

FIG. 6 is an exemplary process flow diagram illustrating a method 300 for performing statistical hypothesis testing to determine if the presence of the unidentified road sign impacts the occurrence of the specific allowed maneuver by the statistical impact module 48 of the one or more central computers 20. It is to be appreciated that the method 300 is to perform statistical hypothesis testing on a single road sign and is repeated for each individual road sign. Referring generally to FIGS. 1-6, the method 300 may begin at block 302. In block 302, the statistical impact module 48 receives a total number no of all maneuver observations without the presence of the unidentified road sign from the telemetry data 30. The method 300 may then proceed to block 304.

In block 304, the statistical impact module 48 receives a total number n₁ of all maneuver observations with the presence of the unidentified road sign from the telemetry data 30. The method 300 may then proceed to block 306.

In block 306, the statistical impact module 48 receives a total number k₀ of observations with the specific allowed maneuver without the presence of the unidentified road sign from the telemetry data 30, hence the total number k₀ of observations specifies the specific maneuver from all the total number no of all maneuver observations. The method 300 may then proceed to block 308.

In block 308, the statistical impact module 48 receives a total number k₁ of observations with the specific allowed maneuver with the presence of the unidentified road sign from the telemetry data 30, hence the total number k₁ of observations specifies the total number n₁ of all maneuver observations. The method 300 may then proceed to block 310.

In block 310, the statistical impact module 48 computes a posterior distribution of a change in probability of the specific allowed maneuver with and without the presence of the unidentified road sign. As an example, binomial distribution may be used to computer a probability distribution. The method 300 may then proceed to block 312.

In block 312, the statistical impact module 48 computes the posterior probability of changes in maneuvers with and without the unidentified road sign. The statistical impact module 48 defines the null hypothesis H0 as the road sign having no impact on the selected specific maneuver. In contrast, the alternate hypothesis Ha is the impact of the unidentified road sign is statistically significant. The method 300 may then proceed to decision block 314.

In decision block 314, if a corresponding test statistic selected for hypothesis testing is below a threshold value, then the method 300 proceeds to block 316. An example of the test statistic is the ROPE test. In block 316, the statistical impact module 48 determines an absence of a relationship between the unidentified road sign and the specific allowed maneuver. The method 200 may then terminate. However, if the corresponding test statistic is equal to or greater than the threshold value, then the method 300 proceeds to block 318, and the statistical impact module 48 determines a relationship exists between the unidentified road sign and the specific allowed maneuver. The threshold value is selected to indicate no effect is observed with the presence of the road sign. The method 300 may then terminate.

Referring generally to the figures, the disclosed crowd-sourced road sign interpretation system provides various technical effects and benefits. Specifically, the crowd-sourced road sign interpretation system provides an approach for interpretating road signs based on crowdsourced telemetry data that requires less computational resources than some of the approaches presently available. The disclosed approach for associating unidentified road signs with a specific allowed maneuver based on the analyzing the telemetry data by the statistical hypothesis test may be especially advantageous in situations where road signs are ambiguous and are difficult to interpret, such as informational road signs or dynamic road signs that change explicit instructions or information over time. Finally, it is to be appreciated that the crowd-sourced road sign interpretation system may be part of an overall sign interpretation system for an automated driving system (ADS) or an advanced driver assistance system (ADAS) to assist the overall sign interpretation system with interpreting vague or unreadable road signs, which is used in motion planning of a vehicle.

The central computer may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the central computer may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A crowd-sourced road sign interpretation system, comprising:
a plurality of vehicles that each include a plurality of sensors and systems that collect telemetry data and perception data, wherein the perception data includes image data of a plurality of unidentified road signs; and
one or more central computers in wireless communication with each of the plurality of vehicles and a network that transmits map data, wherein the one or more central computers execute instructions to:
classify portions a road represented by the map data into a plurality of scenarios;
match the telemetry data from the plurality of vehicles to a specific scenario where the telemetry data was originally collected by one of the plurality of vehicles;
segment a trajectory into a plurality of trajectory segments based on an allowed maneuver and a speed limit associated with each trajectory segment;
group the telemetry data collected at the plurality of trajectory segments based on the presence of one or more unidentified road signs;
perform a statistical hypothesis test of the telemetry data collected at one or more trajectory segments including a specific allowed maneuver and the presence of the one or more unidentified road signs and the telemetry data collected at one or more trajectory segments including the specific allowed maneuver without the presence of the one or more unidentified road sign to determine a statistical impact of the presence of the one or more unidentified road signs upon the specific allowed maneuver; and
in response to determining the one or more unidentified road signs are statistically correlated with the specific allowed maneuver, associate the one or more unidentified road signs with the specific allowed maneuver.

2. The crowd-sourced road sign interpretation system of claim 1, wherein the one or more central computers execute instructions to:
in response to determining the one or more unidentified road signs are not statistically correlated with the specific allowed maneuver, determine an absence of a relationship between the one or more unidentified road signs and the specific allowed maneuver.

3. The crowd-sourced road sign interpretation system of claim 1, wherein the one or more central computers execute instructions to:
in response to determining the absence of a relationship between the one or more unidentified road signs and the specific allowed maneuver, select another unique maneuver as the specific allowed maneuver; and
re-execute the statistical hypothesis test of the telemetry data.

4. The crowd-sourced road sign interpretation system of claim 1, wherein a scenario refers to a geometry, a capacity, and an allowed maneuver associated with a specific portion of the road.

5. The crowd-sourced road sign interpretation system of claim 1, wherein the one or more unidentified road signs represent a cluster of unidentified road signs that each share the same message conveyed by an identifier.

6. The crowd-sourced road sign interpretation system of claim 5, wherein the identifier includes one of more of the following: text and symbols.

7. The crowd-sourced road sign interpretation system of claim 5, wherein the one or more central computers execute instructions to:
receive the perception data from the plurality of vehicles, wherein the perception data includes the image data of the plurality of unidentified road signs; and
interpret the plurality of unidentified road signs to determine the identifier associated with each of the plurality of unidentified road signs.

8. The crowd-sourced road sign interpretation system of claim 7, wherein the one or more central computers execute instructions to:
determine one or more clusters of unidentified road signs based on the identifiers associated with each of the plurality of unidentified road signs, wherein each cluster of unidentified road signs share the same information conveyed by the identifier.

9. The crowd-sourced road sign interpretation system of claim 7, wherein the image data includes a road sign with two or more separate identifiers, and wherein the one or more central computers execute instructions to:
parse the road sign into two or more unique identifiers, wherein the two or more unique identifiers are each analyzed as a separate road sign.

10. The crowd-sourced road sign interpretation system of claim 1, wherein the statistical hypothesis test includes one of the following: Fisher's exact test and Bayesian Region of Practical Equivalence (ROPE).

11. The crowd-sourced road sign interpretation system of claim 1, wherein the unidentified road signs include dynamic road signs.

12. A method for associating unidentified road signs with a specific allowed maneuver based on a statistical hypothesis test of telemetry data collected by a plurality of vehicles, the method comprising:
classifying, by one or more central computers, portions a road represented by map data into a plurality of scenarios, wherein the one or more central computers are in wireless communication with each of the plurality of vehicles and a network that transmits the map data;
matching the telemetry data from the plurality of vehicles to a specific scenario where the telemetry data was originally collected by one of the plurality of vehicles;
segmenting a trajectory into a plurality of trajectory segments based on an allowed maneuver and a speed limit associated with each trajectory segment;
group the telemetry data collected at the plurality of trajectory segments based on the presence of one or more unidentified road signs;
performing a statistical hypothesis test of the telemetry data collected at one or more trajectory segments including a specific allowed maneuver and the presence of the one or more unidentified road signs and the telemetry data collected at one or more trajectory segments including the specific allowed maneuver without the presence of the one or more unidentified road sign to determine a statistical impact of the presence of the one or more unidentified road signs upon the specific allowed maneuver; and
in response to determining the one or more unidentified road signs are statistically correlated with the specific allowed maneuver, associating the one or more unidentified road signs with the specific allowed maneuver.

13. The method of claim 12, wherein the method further comprises:
in response to determining the one or more unidentified road signs are not statistically correlated with the specific allowed maneuver, determining an absence of a relationship between the one or more unidentified road signs and the specific allowed maneuver.

14. The method of claim 12, wherein the method further comprises:
in response to determining the absence of a relationship between the one or more unidentified road signs and the specific allowed maneuver, selecting another unique maneuver as the specific allowed maneuver; and
re-executing the statistical hypothesis test of the telemetry data.

15. The method of claim 12, wherein the method further comprises:
receiving perception data from the plurality of vehicles, wherein the perception data includes image data of a plurality of unidentified road signs; and
interpreting the plurality of unidentified road signs to determine an identifier associated with each of the plurality of unidentified road signs.

16. The method of claim 15, wherein the method further comprises:
determining one or more clusters of unidentified road signs based on the identifiers associated with each of the plurality of unidentified road signs, wherein each cluster of unidentified road signs share the same information conveyed by the identifier.

17. A crowd-sourced road sign interpretation system, comprising:
a plurality of vehicles that each include a plurality of sensors and systems that collect telemetry data and perception data, wherein the perception data includes image data of a plurality of unidentified road signs; and
one or more central computers in wireless communication with each of the plurality of vehicles and a network that transmits map data, wherein the one or more central computers execute instructions to:
classify portions a road represented by the map data into a plurality of scenarios, wherein a scenario refers to a geometry, a capacity, and an allowed maneuver associated with a specific portion of the road;
match the telemetry data from the plurality of vehicles to a specific scenario where the telemetry data was originally collected by one of the plurality of vehicles;
segment a trajectory into a plurality of trajectory segments based on an allowed maneuver and a speed limit associated with each trajectory segment;
group the telemetry data collected at the plurality of trajectory segments based on the presence of one or more unidentified road signs;
perform a statistical hypothesis test of the telemetry data collected at one or more trajectory segments including a specific allowed maneuver and the presence of the one or more unidentified road signs and the telemetry data collected at one or more trajectory segments including the specific allowed maneuver without the presence of the one or more unidentified road sign to determine a statistical impact of the presence of the one or more unidentified road signs upon the specific allowed maneuver;
in response to determining the one or more unidentified road signs are statistically correlated with the specific allowed maneuver, associate the one or more unidentified road signs with the specific allowed maneuver;
in response to determining the one or more unidentified road signs are not statistically correlated with the specific allowed maneuver, determine an absence of a relationship between the one or more unidentified road signs and the specific allowed maneuver; and
in response to determining the absence of the relationship between the one or more unidentified road signs and the specific allowed maneuver, select another unique maneuver as the specific allowed maneuver; and
re-execute the statistical hypothesis test of the telemetry data.

18. The crowd-sourced road sign interpretation system of claim 17, wherein the one or more unidentified road signs represent a cluster of unidentified road signs that each share the same message conveyed by an identifier.

19. The crowd-sourced road sign interpretation system of claim 18, wherein the identifier includes one of more of the following: text and symbols.

20. The crowd-sourced road sign interpretation system of claim 19, wherein the one or more central computers execute instructions to:
receive the perception data from the plurality of vehicles, wherein the perception data includes the image data of the plurality of unidentified road signs; and
interpret the plurality of unidentified road signs to determine the identifier associated with each of the plurality of unidentified road signs.
